(19) United States
(12) Patent Application Publication
(10) Pub. No.: US 2015/0066915 A1
(43) Pub. Date: Mar. 5, 2015

(54) System and Method for Group Recommendation of Objects Using User Comparisons of Object Characteristics

(71) Applicant: Google Inc., Mountain View, CA (US)

(72) Inventors: Scott Golder, Seattle, WA (US); Ed Huai-Hsin Chi, Palo Alto, CA (US); David Andrew Huffaker, Mountain View, CA (US); Gueorgi Kossinets, San Francisco, CA (US)

(21) Appl. No.: 13/712,046

(22) Filed: Dec. 12, 2012

Related U.S. Application Data
(60) Provisional application No. 61/728,257, filed on Nov. 20, 2012.

(51) Int. Cl. G06F 17/30

(52) U.S. Cl. CPC G06F 17/3053
USPC 707/723

(57) ABSTRACT

Systems and methods for determining a group recommendation of an object, such as a restaurant, movie, or other object, from a plurality of candidate objects based on user comparisons of characteristic traits of the candidate objects are provided. In particular, keywords associated with characteristic traits are identified. The keywords are then presented to members of the group as a series of selection queries. The selection queries require a user to select or rank the keywords based on user preferences. The responses to the selection queries are used to generate a ranking score for each of the plurality of candidate objects and to select one or more of the candidate objects to recommend to the group.

### PRIORITY CLAIM

This application claims the benefit of priority of U.S. Provisional Patent Application Ser. No. 61/728,257 filed on Nov. 20, 2012, which is incorporated herein by reference for all purposes.

### FIELD

The present disclosure relates generally to providing automated recommendations, and more particularly to a system and method of providing automated recommendations to a group based on comparisons of object characteristics.

### BACKGROUND

Individuals can make choices from a set of objects according to the individual's own preferences. However, when groups of individuals are working together to choose an object from a set of objects, reaching agreement or consensus among the group is difficult because the individuals have different preferences. For example, a group of individuals working together to select a restaurant can have difficulty reaching an agreement on a particular restaurant as a result of different dining preferences by the individuals in the group.

One approach to providing an object recommendation for a group is to use algorithms to produce acceptable recommendations in the face of heterogeneous preferences provided by individuals in the group. However, algorithms can have difficulty achieving a group ranking of objects while also meeting a specified set of criteria, such as allowing for all the individual preferences of a group and providing for non-dictatorship of a single individual in the group.

Collaborative filtering technology and other recommender systems have been developed that generally make recommendations to individuals based on past preferences and behavior of the individuals and based on the preferences and behaviors of others. However, collaborative filtering technology generally makes recommendations based on one individual's preferences and not the preferences of a group. In addition, collaborative filtering technology typically requires a body of existing information about the preferences or behavior of users before making a recommendation. Finally, collaborative filtering technology generally makes group recommendations based on user preferences between the objects themselves as opposed to preferences between characteristic traits of the objects.

### SUMMARY

Aspects and advantages of the invention will be set forth in part in the following description, or may be obvious from the description, or may be learned through practice of the invention.

One exemplary aspect of the present disclosure is directed to a computer-implemented method of providing a recommendation to a group of at least one object from a plurality of candidate objects. The method includes identifying, with a computing device, a plurality of keywords associated with the plurality of candidate objects and providing a plurality of selection queries to each of a plurality of users in the group. Each of the plurality of selection queries requires a user to select one or more of the plurality of keywords based on user preferences. The method further includes receiving a response to each of the plurality of selection queries from the plurality of users; and generating, with the computing device, a ranking score for each of the plurality of candidate objects based on the responses to the plurality of selection queries.

Other exemplary aspects of the present disclosure are directed to systems, apparatus, non-transitory computer-readable media, user interfaces and devices for providing a group recommendation of an object based on user comparisons of object characteristics.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary system for providing group recommendations according to an exemplary embodiment of the present disclosure;

FIGS. 2-5 depict exemplary user interfaces for providing group recommendations according to an exemplary embodiment of the present disclosure;

FIGS. 6A and 6B depicts a flow diagram of an exemplary method according to an exemplary embodiment of the present disclosure;

FIG. 7 depicts a flow diagram of an exemplary method for generating a ranking score based on user responses to selection queries according to an exemplary embodiment of the present disclosure; and

FIG. 8 depicts an exemplary computing environment for implementing the systems and methods according to exemplary embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to a system and method for making a recommendation of an object(s), such as a restaurant, movie, or other object, from a set of candidate objects to a group of users based on user comparisons of characteristic traits of the candidate objects. As used herein, a “characteristic trait” of an object can be a descriptive aspect or feature associated with the object, but does not include the name of the object or the object itself. The object(s) recommended to the group can be selected to best suit the preferences of the group as a whole, as opposed to individual users in the group. The group decision capability of the present disclosure can be used by a group of users to assist a user in selecting an object from a plurality of candidate objects. For instance, a group recommendation provided in accordance with the present disclosure can be used to assist a group of users in selecting, for instance, a restaurant, a movie, or other object for the group.

More particularly, a user that is part of a group faced with selecting an object, such as restaurant, movie, or other object, can request that a host system initiate a group decision session for the group. The user can also request that other members of the group be invited to participate in the group decision session. The users can interact with the host system using client devices, such as smartphones, tablets, mobile devices, computers, or other devices in communication with the host system.

Once the group decision session has been initiated, a host system can identify a plurality of keywords associated with characteristic traits of the plurality of candidate objects. For instance, the host system can access a data store storing information associated with the candidate objects and extract keywords associated with characteristic traits of the candidate objects. The keywords can be terms, clauses, phrases, or other words associated with descriptive features or aspects of the candidate objects. Example keywords associated with characteristics traits of restaurants can include, “fine dining,” “quiet atmosphere,” “great meatballs,” “Mexican cuisine,” “casual atmosphere,” “dim lighting,” “Japanese fusion,” “famous eggplant,” “vegetarian,” “rude staff,” or other suitable keywords associated with characteristic traits of restaurants. The host system can identify keywords from a data store storing information associated with the candidate objects, such as reviews, comments, blogs, web pages, and other information associated with the candidate objects.

After a plurality of keywords associated with characteristic traits of the candidate objects have been identified, the plurality of keywords can be presented to the users in the group as a series of selection queries. The selection queries can be presented in a suitable user interface presented on display of a device accessed by a user. The selection queries can require the users to compare two or more of the keywords and to select or rank the keywords based on user preferences. For instance, in one implementation, the selection queries can require the users to select between one of two keywords as part of a pairwise decision. An example pairwise decision can require a user to select between the keywords “vegetarian” and “dim lighting.” In another implementation, the selection queries can require users to rank a plurality of keywords. For instance, a selection query can require a user to rank the keywords “famous eggplant,” “rude staff,” and “fine dining.” The keywords can be selected for presentation to the users at random and/or based on the number of candidate objects associated with the keywords

The host system can present a series of selection queries to the users of the group until a condition is satisfied. For instance, the host system can present a series of selection queries until the host system has enough information to provide a recommendation. Alternatively or in addition, the host system can present a series of selection queries until the host system has received a predetermined number of responses to the selection queries or until a predetermined amount of time has elapsed.

Once the host system has received a number of responses to the selection queries from the members of the group, the host system can generate a ranking score for each of the candidate objects based on the responses to the selection queries. The ranking score can be generated using any suitable ranking algorithm that assigns ranks based on the user responses to the selection queries. For instance, when a user selects a keyword as part of a selection query, that keyword can receive a point value, such as one point. In turn, all of the candidate objects associated with that keyword can also receive a point value. The point value for each candidate object can then be summed and used to generate a ranking score for the candidate object.

Candidate objects with the higher ranking scores can then be presented to the user as recommendations to the group. For instance, one or more restaurants, movies, or objects can be recommended to the group. The group can then rely on the recommendation(s) in selecting an object from the plurality of candidate objects. In one implementation, users can be granted veto power over the recommendations so that a user can veto a recommendation in cases where the recommended object is simply not suitable for the user.

In this manner, the subject matter of the present disclosure can assist a group of users in selecting a candidate object, such as a restaurant, movie, or other object, from a plurality of candidate of objects. By relying on user responses to a plurality of selection queries involving random characteristic traits of the candidate objects, the cognitive load on individuals making the group decision can be reduced. Indeed, members of the group can consider responding to the selection queries as a fun game that can build social cohesion among the group. In this way, the systems and methods for providing group recommendations according to aspects of the present disclosure can reduce interpersonal disagreements during the selection process while increasing the speed and likelihood of consensus on selecting an object.

The group recommendation(s) can also be provided without knowledge or information of a user's past behavior or general preferences. The recommendation(s) can be generated based on quick bootstrapping of user preferences as provided in response to the selection queries. This allows the group recommendation(s) to support dynamically changing contexts (e.g. the group is not in the usual location) and ephemeral preferences (e.g. a member of the group generally likes Mexican food, but not tonight).

### Exemplary System for Providing a Group Recommendation

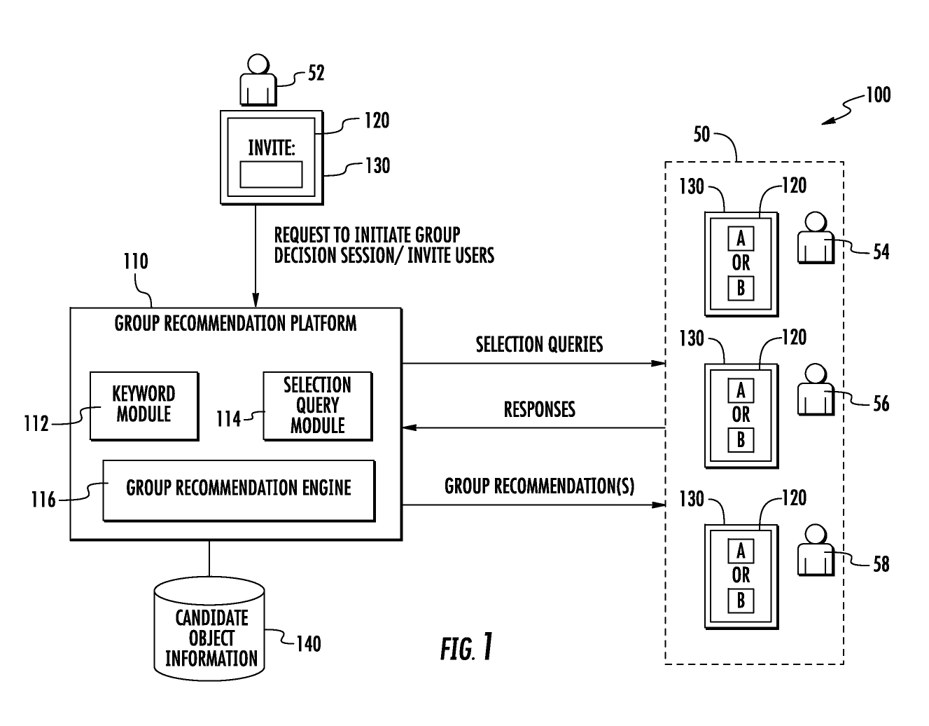

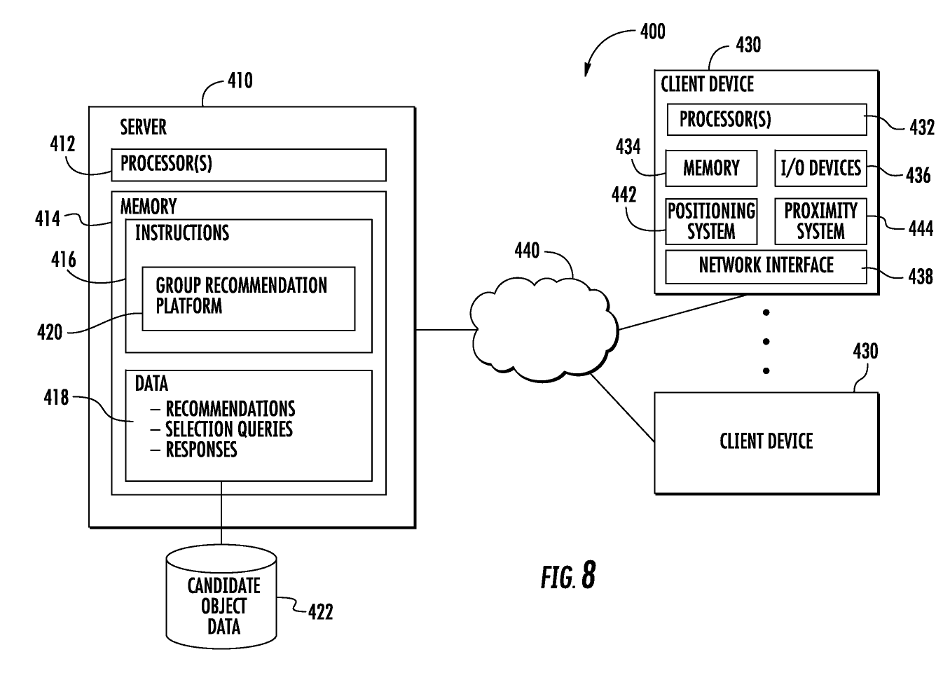

FIG. 1 depicts an overview of exemplary system 100 for providing a recommendation of an object, such as a restaurant, movie, or other object, from a plurality of candidate objects according to an exemplary embodiment of the present disclosure. The system 100 can be implemented using any suitable computing environment, such as the computing environment depicted in FIG. 8. The system 100 of FIG. 1 includes a group recommendation platform 110 that can be used to generate a group recommendation of an object for a group 50 according to exemplary aspects of the present disclosure. The group recommendation platform 110 can be hosted by a server, such as a web server. A member of the group 50 can interact with the group recommendation platform 110 using a group decision module 120 implemented on a computing device 130 accessible by the member of the group 50, such as a laptop, desktop, mobile device, smartphone, tablet, PDA, or other computing device, that is in communication with the group recommendation platform 110, for instance, over a network.

It will be appreciated that the term “module” refers to computer logic utilized to provide desired functionality. Thus, a module can be implemented in hardware, firmware, application specific circuits, and/or software controlling a general purpose processor. In one embodiment, the modules are program code files stored on the storage device, loaded into memory and executed by a processor or can be provided from computer program products, for example computer executable instructions, that are stored in a tangible computer-readable storage medium such as RAM, ROM, hard disk or optical or magnetic media.

More particularly, a user 52 can interact with a group decision module 120 to send a request to initiate a group decision session to the group recommendation platform 100. For instance, the user 52 can interact with a suitable user interface implemented by the group decision module 120 that allows for the creation and the joining of a group. The user 52 can send invitations to other users, such as users 54, 56, and 58, via the group recommendation platform 110 to invite the users to join the group decision session. While user 52 is not illustrated as being a part of group 50 in FIG. 1, those of ordinary skill in the art, using the disclosures provided herein, will understand that user 52 can be a part of or separate from the group 50 without deviating from the scope of the present disclosure.

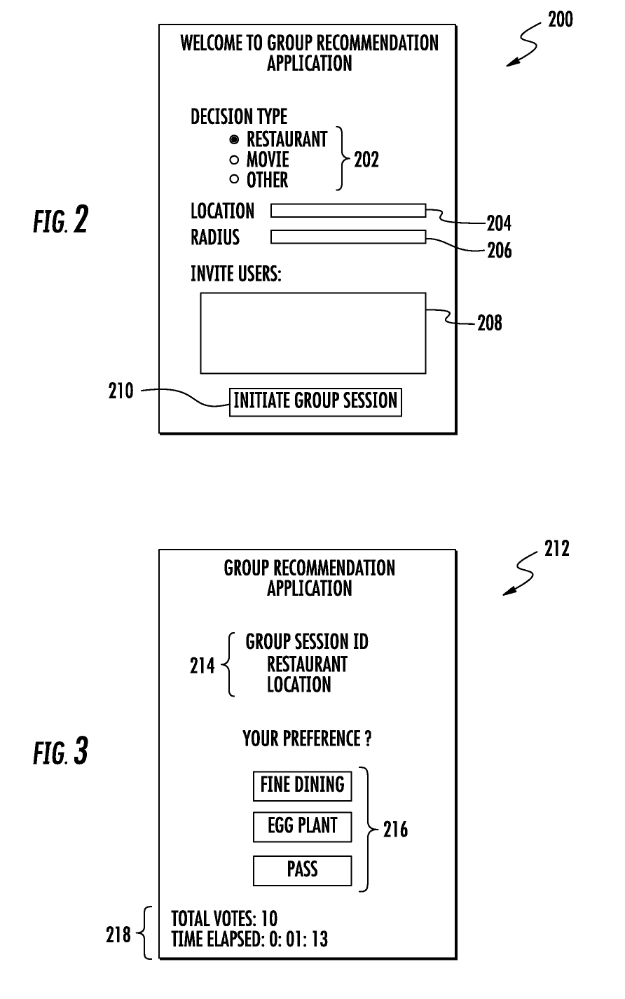

FIG. 2 depicts an exemplary user interface 200 that can be presented to user 52 to allow the user 52 to initiate a group decision session and invite users to join the group according to an exemplary embodiment of the present disclosure. The user interface 200 can include fields 202 to allow the user to select the type of candidate object for the group decision session, such as restaurant, movie, or other type of candidate object. The user interface 200 can also include other fields to allow the user to select various selection criteria for the group decision session. For instance, the user interface 200 includes a location field 204 and a radius field 206 so that a user can specify location settings to restrict the set of candidate objects to objects within a specified radius of the specified location. The specified location can be manually entered by the user in the field 204. Alternatively, the specified location can be based on position data optionally provided by the user indicative of the current position of the user as determined by, for instance, a positioning system, such as a GPS system or other suitable positioning system. The user 52 can have control over how the position data is used by the group recommendation platform 110.

The defined radius can be manually entered or selected from a list in field 206. The defined radius can also be a default condition that does not have to be specified every instance by the user. Other suitable fields/inputs can be provided in the user interface 200 to allow the user input selection criteria for the group decision session. For instance, fields can be provided to allow the user to specify time restrictions, such as movie time restrictions, price limits, etc.

Referring still to FIG. 2, the user interface 200 can include a field 208 that allows the user to invite other users to join the group. The user can manually input the other users into the field 208 or contact information, social network information, or other information, associated with the user can be accessed and presented to the user as candidates to join the group. The user can then select which of the contacts the user desires to invite to join the group. The user can complete the request to initiate the group session by interacting (e.g. clicking or tapping) with the initiate group session control tool 210.

In situations in which the systems discussed herein collect personal information about users, or make use of personal information, such as position information or contact information, the users may be provided with an opportunity to control whether programs or features collect the information (e.g. the user's contact information, information about a user's social network, social actions or activities, profession, a user's preference or a user's current location), or to control whether and/or how to receive content from the group recommendation platform 110 or other application that may be more relevant to the user. In addition, certain data can be treated in or more ways before it is stored or used, so that personally identifiable information is removed. For example, a user's identify may be treated so that no personally identifiable information can be determined for the user, or a user's location can be generalized where location information is obtained (such as to city, ZIP code, or other level), so that a particular location of a user cannot be determined Thus, the user can have control over how information is collected about the user and used by the group recommendation platform 110 or other application.

Referring back to FIG. 1, the group decision platform 110 can initiate the group decision session in response to the request from the user 52 and assign the group decision session a unique session identifier. The group decision platform 110 can then invite specified users to join the group. In one example, the group decision platform 110 can send invitations to the specified users, 54, 56, and 58 to join the group decision session. The users 54, 56, and 58 can join the group by accepting the invitation. Other suitable methods for joining the group decision session can be provided. For instance, a user can search for or identify a group decision session by unique session id and join the group decision session. Alternatively, users can instantly join a created group decision session using proximity detection systems (e.g. a Bluetooth system, near field communication system, or other suitable system) by touching or bringing devices in proximity with one another.

Once several users, such as users 54, 56, and 58, have joined the group, the group recommendation platform 110 can identify a set of candidate objects based on the settings input by the user 52. For instance, as discussed above, the group recommendation platform 110 can access candidate object information stored in the data store 140 and identify a set of candidate object within a specified radius of a location specified by or associated with the user 52 and that satisfy other constraints specified by the user 52.

After the plurality of candidate objects have been identified, the group recommendation platform 110 can implement a keyword module 112 to identify keywords associated with the plurality of candidate objects. In particular, the keyword module 112 can access the data store 140 of candidate object information and extract keywords associated with characteristic traits of the candidate objects. For instance, the keyword module 112 can access comments, reviews, blogs, web pages, and other information associated with the candidate objects and extract keywords associated with characteristic traits of the plurality of candidate objects from the information.

Any suitable keyword extraction technique can be used by the keyword module 112 to identify the plurality of keywords associated with characteristics traits of the candidate objects. For instance, the information stored in the data store 140 can be analyzed using data mining techniques to identify specific predefined keywords in the information stored in the data store 140. The predefined keywords can be a set of typical keywords associated with the type of candidate objects. For example, a set of typical keywords associated with characteristics traits restaurants can be predefined or collected. The set of typical keywords can include many thousands of keywords that can be associated with characteristic traits of restaurants. Information associated with candidate restaurants, such as web pages, blogs, reviews, etc., can be searched using the keyword module 112 to identify any of the predefined set of keywords in the information. The identified keywords can be extracted and used in accordance with aspects of the present disclosure.

The plurality of identified keywords can be passed to a selection query module 114 which generates a plurality of selection queries for presentation to users 54, 56, and 58 of the group. In particular, the selection query module 114 selects two or more keywords to be used as part of each selection query. The keywords can be selected at random or can be based on any suitable factor, such as the number of candidate objects associated with the particular keyword.

The selection queries can be provided to computing devices 130 associated with the users 54, 56, and 58 and can be presented to the users 54, 56, and 58 in a user interface implemented by a group recommendation module 120. In one example, the selection queries can require a user to select one of two keywords as part of a pairwise decision. In another example, the selection queries can require a user to rank two or more keywords. The users 54, 56, and 58 can respond to the selection queries based on user preferences.

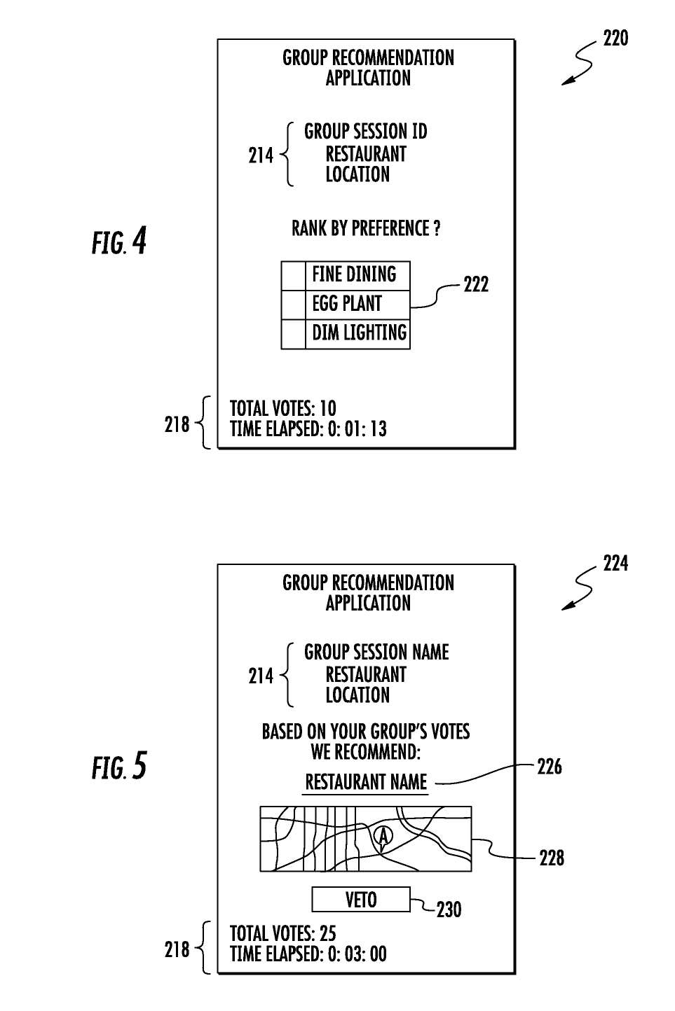

FIG. 3 depicts an exemplary user interface 212 presenting a selection query that requires a user to select one of two keywords as part of a pairwise decision. The user interface 212 can present unique session identifier 214 including descriptive information associated with the group decision session in the user interface 212. The user interface can also present tools 216 allowing a user to select between one of two keywords or to “pass” in response to the selection query. In the example depicted in FIG. 3, the selection query requires the user to select between “fine dining” and “eggplant.” A user can select either “fine dining” or “eggplant” based on user preferences. If the user has no preference, the user can elect to “pass.” The user interface 212 can present additional information 218 to the user such as total votes and amount of time elapsed during the group decision session.

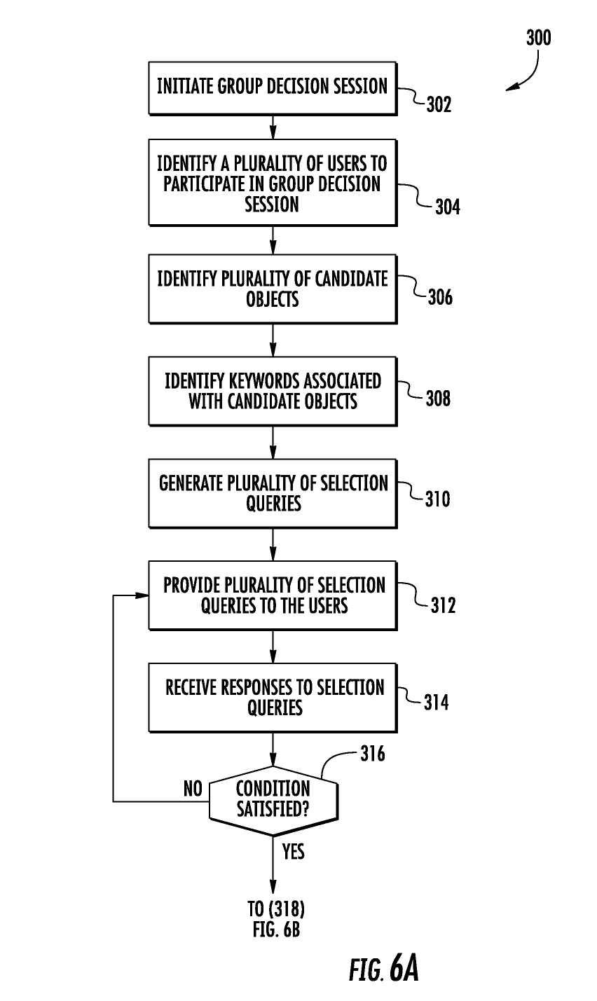

FIG. 4 depicts an exemplary user interface 220 presenting a selection query that requires a user to rank three keywords. Similar to the exemplary user interface 212, the user interface 220 can present the unique session identifier 214 and additional information 218 such as total votes and amount of time elapsed during the group decision session. In addition, the user interface 220 includes a ranking tool 222 that allows the user to rank a plurality of keywords. In the example depicted in FIG. 4, the ranking tool 222 allows the user to rank the keywords “fine dining,” “egg plant,” and “dim lighting” based on user preferences. The ranking tool 222 can be any suitable interface for ranking the keywords. For instance, the ranking tool 222 can allow the user to manipulate the order of the keywords in a stack presented in the ranking tool.

Referring back to FIG. 1, the selection queries can be presented to the users 54, 56, and 58 until a condition is satisfied. For instance, the group recommendation platform 110 can present a series of selection queries until the group recommendation engine 116 has enough information to provide a recommendation. Alternatively or in addition, the group recommendation platform 110 can present a series of selection queries until the group recommendation platform 110 has received a predetermined number of responses to the selection queries or until a predetermined amount of time has elapsed.

The group recommendation platform 110 can receive the responses to the selection queries and generate group recommendation(s) based on the responses using the group recommendation engine 116. In particular, the group recommendation engine 116 can assign ranking scores to the candidate objects based on the responses to the selection queries using any suitable ranking algorithm. The candidate object(s) with the highest ranking scores can be provided to the computing devices 130 associated with users 54, 56, and 58 as group recommendation(s).

The group recommendation(s) can be presented to the users 54, 56, and 58 in a suitable user interface implemented by a group recommendation module 120. FIG. 5 depicts an exemplary user interface 224 for presenting a group recommendation to the users 54, 56, and 58 in the group 50. Similar to the user interface 212, the user interface 220 can present the unique session identifier 214 and additional information 218 such as total votes and amount of time elapsed during the group decision session. In addition, the user interface 224 can present the group recommendation 226 as well as additional information associated with the group recommendation 226, such as a mapping tool 228 providing the location of the group recommendation 226 relative to members of the group. A user can interact with the group recommendation 226 to obtain additional information, such as a web page, comments, blogs, and other information associated with the group recommendation 226.

The user interface 224 can also include a veto tool 230 to allow a user to veto the group recommendation. For instance, a user displeased with the group recommendation 226 can interact with the veto tool 230 to veto the group recommendation 226. The group recommendation platform 110 of FIG. 1 can receive the veto decision and remove the candidate object subject to the veto decision from the plurality of candidate objects. The group recommendation platform 110 can then provide an alternative group recommendation to the group 50.

### Flow-Diagram of an Exemplary Method for Providing Group Recommendations

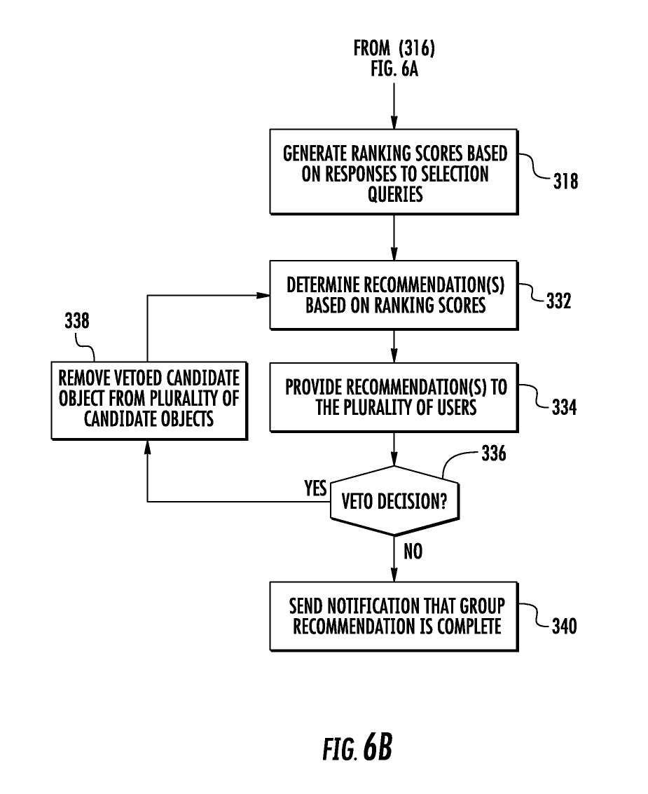

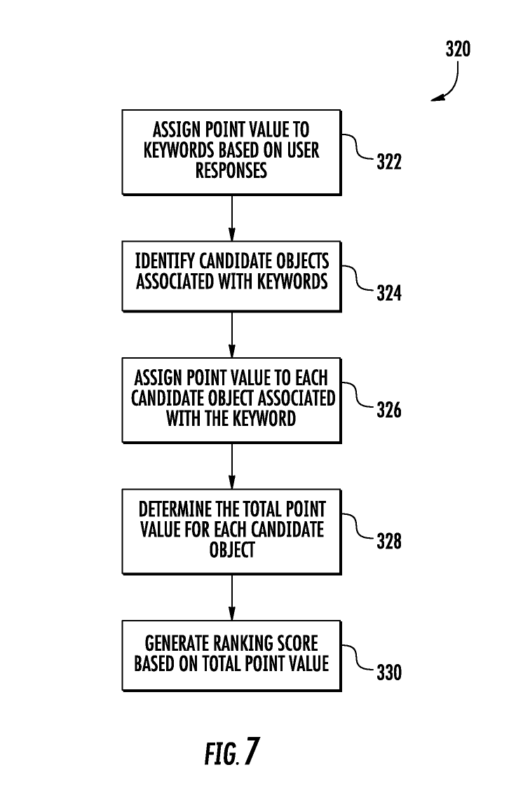

FIGS. 6A and 6B depict a flow diagram of an exemplary method (300) of generating a group recommendation according to an exemplary embodiment of the present disclosure. The method (300) will be discussed with reference to the computer-implemented system 100 of FIG. 1. However, the method (300) can be implemented using any suitable computer implementation. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (302), the method includes initiating a group decision session. For instance, the group recommendation platform 110 of FIG. 1 can initiate a group decision session in response to a request to initiate a group decision session received from a user. The group recommendation platform 100 can assign the group decision session a unique session id.

A plurality of users to participate in the group decision session can be identified at (304). The group recommendation platform 110 of FIG. 1, for instance, can identify users that are members of a group and establish communication with devices associated with the identified users. The users can be identified based on invitations specified in the request to initiate the group decision session. The group recommendation platform 110 can send the invitations to the invited users and can identify users that have accepted invitations as participants of the group decision session. The group recommendation platform 110 can also identify users that have joined the group decision session using other suitable techniques, such as by identifying a particular group decision session by unique session id or by instantly joining a group session using a proximity detection system.

At (306), the method includes identifying a plurality of candidate objects for the group decision session. The plurality of candidate objects will serve as the base set from which the group recommendation(s) will be selected. The plurality of candidate objects can be identified based on user settings, such as user setting specifying the type of candidate object and specifying constraints for the plurality of candidate objects. For example, the group recommendation platform 110 can identify a plurality of candidate objects based on the type of candidate object (e.g. restaurant, movie, or other object) provided in the request to initiate the group decision session. As another example, the group recommendation platform 110 can identify a plurality of candidate objects satisfying location constraints specified by a user, such as constraints requiring the candidate objects to be within a specified radius of a particular location. The plurality of candidate objects can also be identified based on other user settings and/or constraints, such as time constraints, reservation availability, price limits, etc.

A plurality of keywords associated with the plurality of candidate objects are identified at (308). For instance, the keyword module 112 can access information associated with the plurality of candidate objects, such as web pages, comments, reviews, and other information, stored in a data store 140 and extract keywords associated with characteristic traits of the candidate objects. The keywords can be identified using any suitable keyword extraction technique. For instance, the keyword module 112 can scan information stored in the data store 140 to identify keywords associated with one or more of the plurality of candidate objects. The associations between an identified keyword and one or more of the plurality of candidate objects can be maintained for purposes of implementing a ranking algorithm to rank the candidate objects based on user preferences between the keywords.

At (310), the method includes generating a plurality of selection queries. For instance, keywords identified by the keyword module 112 can be passed to the selection query module 114 that will use the keywords to generate a plurality of selection queries for presentation to members of a group. Each of the plurality of selection queries can require a user to select or rank one or more keywords based on user preferences. In one implementation, the keywords can be selected for a selection query module at random to enhance user interaction with the group recommendation module. In particular, user experience can be improved by presenting selection queries to the user with humorous random combinations of keywords.

Alternatively or in addition, the keywords can be selected based on the number of candidate objects associated with a particular keyword. For instance, keywords that are associated with either a relatively large or, in alternative implementation, a relatively small number of candidate objects, can be selected more often for inclusion in a selection query. In particular, a weighting value can be assigned to a keyword based on the number of candidate objects associated with the keyword. The keyword can be selected to be used as part of a selection query based on the weighting value.

The selection queries are provided to the plurality of users participating in the group decision session at (312). For instance, the group recommendation platform 110 can communicate the selection queries to devices associated with members of the group over a network. The same or different sets of selection queries can be provided to the different members of the group. The selection queries can be presented to the members of the group using a suitable user interface. The users can respond to the selection queries by identifying or ranking the keywords presented in each selection query based on user preferences. Responses to the selection queries are received at (314). For instance, the group recommendation platform 110 can receive responses to the selection queries from the group recommendations modules 120 over a network.

At (316), the method determines whether a condition is satisfied. For instance, the group recommendation platform 110 can provide and receive responses to a series of selection queries to the users of the group until a condition is satisfied. In one implementation, the condition is satisfied when the group recommendation platform 110 has enough information to provide a recommendation. In other implementations, the condition can be satisfied after the expiration of a period of time or after a predetermined number of responses to the selection queries has been received. If the condition is not satisfied, the method continues to provide selection queries to users (312) and receive responses to the selection queries (314) until the condition is satisfied.

Once the condition is satisfied, the method includes generating ranking scores for each of the plurality of candidate objects based on the responses to the selection queries as shown at (318) of FIG. 6B. For instance, the group recommendation platform 110 can implement the group recommendation engine 116 to generate ranking scores for each of the plurality of candidate objects. Any suitable ranking algorithm can be used that ranks the plurality of candidate objects based on user preferences of keywords associated with the candidate objects.

FIG. 7 depicts a flow diagram of an exemplary method (320) that can be used to generate ranking scores for the plurality of candidate objects based on user responses to the selection queries according to an exemplary embodiment of the present disclosure. The method (320) can be implemented using any suitable computer implementation, such as the group recommendation engine 116 implemented by the group recommendation platform 110 of FIG. 1.

At (322), a point value is assigned to keywords based on user responses to the selection queries. For instance, each time a user selects a keyword in response to a selection query, the keyword can be assigned one point. Different point values can be assigned based on the responses to the selection query. For instance, if the selection queries require a user to rank keywords, the keywords can be assigned different point values based on the rankings provided by the user.

At (324), candidate objects associated with each of the keywords are identified. The candidate objects can be identified based on associations between candidate objects and keywords identified during keyword extraction. At (326), the point values assigned to each keyword are assigned to all candidate objects associated with the keyword. For example, if the keyword “fine dining” is associated with fifteen different candidate objects, the point value assigned to the keyword “fine dining” is assigned to each of the fifteen different candidate objects.

At (328), the point values assigned to each candidate object are tallied to determine the total value for each candidate object. In this way, the total point value for each candidate object is based on the point values assigned to all keywords associated with the candidate object. A ranking score for the candidate object can be generated from the total point value (330). The ranking score can be equal to the total point value assigned to the candidate object or can be determined based on a weighting algorithm or other suitable algorithm as a function of the total point value associated to the candidate object.

Referring back to FIG. 6B at (332), once the ranking score for the candidate objects have been generates, the method can determine recommendation(s) based on the ranking scores. For instance, the group decision engine 114 of the group recommendation platform 110 can determine one or more candidate objects of the plurality of candidate objects to recommend to the group. The recommendation(s) can be determined by identifying the candidate object(s) with the highest ranking scores.

The recommendation(s) are provided to the plurality of users at (334). For instance, the group recommendation platform 110 provides the recommendations to devices 130 associated with members of the group over a network. The group recommendations can be presented to the users in a suitable user interface. Any suitable number of recommendations can be identified and provided to the members of the group without deviating from the scope of the present disclosure. For instance, in one implementation, only one group recommendation is identified and provided to the group. In other implementations, multiple group recommendations can be identified. Multiple group recommendations can be presented in a user interface in order of ranking score to facilitate the decision making process by the group.

At (336), the method includes determining whether a veto decision has been made for a recommended object by a member of the group. For instance, the group recommendation platform 110 can determine whether it has received a veto decision from a user. If so, the object subject to the veto decision can be removed from the plurality of candidate objects for the group decision session (338). The method can then determine new recommendations based on the ranking scores (332) and provide the new recommendations to the group (334). Otherwise, a notification can be sent to the group indicating that the group recommendation is complete (340). For instance, the group recommendation platform 110 can send a notification to members of the group notifying the members of the group that the group recommendation process is complete. The members of the group can then make a decision based on the group recommendation(s).

### Exemplary Computing Environment for Implementing the Group Recommendation Systems and Methods According to Aspects of the Present Disclosure

FIG. 8 depicts an exemplary computing system 400 that can be used to implement the group recommendation systems and methods according to exemplary aspects of the present disclosure. The system 400 can include a client-server architecture where a server 410 communicates with one or more clients 430 over a network 440. Although two clients 430 are illustrated in FIG. 8, any number of clients 430 can be connected to the server 410 over the network 440. In addition, although system 400 is illustrated as a client-server arrangement, one of ordinary skill in the art, using the disclosures provided herein, will recognize that the inherent flexibility of computer-based systems allows for a great variety of possible configurations, combinations, and divisions of tasks and functionality between and among components. For instance, the processes and methods discussed herein can be implemented on a single computing device or across multiple computing devices. As used herein, a computing device can include any machine capable of performing automated computations and can be, a computer, a laptop, a desktop, a mobile device, a smartphone, a tablet, a PDA, any device having a processor, or other suitable computing device.

The server 410 can host a group recommendation application that provides for the group recommendation of candidate objects according to exemplary aspects of the present disclosure. The server can be configured to exchange data with clients 430 over the network 440. For instance, the server 410 can encode data in one or more data files and provide the data files to a client 430 over the network 440

On the client side, each client 430 can execute a group recommendation module that allows the client 430 to interact with the group recommendation application hosted by the server 410. The group recommendation module can present data to the user in a suitable user interface and receive user input. For instance, the client 430 can present various selection queries to a user and receive responses to the selection queries via user input using a suitable user interface. The data input by the user can be encoded in one or more data files and provided to the server 410 over the network 440.

The server 410 can be any computing device and can include one or more processor(s) 412 and a memory 414. The processor(s) 412 can be any suitable processing device such as microprocessor. The memory 414 can include any suitable computer-readable medium or media, including, but not limited to, RAM, ROM, hard drives, flash drives, optical or magnetic media, or other memory devices.

The memory 414 can store instructions 416 which cause the processor(s) 412 to perform operations. For instance, the memory 414 can store instructions 416 to implement the group recommendation platform 110 of FIG. 1, including a keyword module, selection query module, and a group recommendation engine, according to exemplary aspects of the present disclosure. Other modules can be implemented by the server 410. Any number of modules can be programmed or otherwise configured to carry out the functionality described herein. In addition, the various components on the server 410 can be rearranged. Other configurations will be apparent in light of this disclosure and the present disclosure is not intended to be limited to any particular configuration.

The memory 114 can also store data 418, such as selection query data, response to selection query data, recommendation data, and other data used in the system 400. The memory 114 can include or be coupled to a data store 422 storing candidate object information, such as web pages, comments, blogs, reviews, etc., associated with a plurality of candidate objects. The server 410 can communicate with other databases as needed. The databases can be connected to the server 410 by a high bandwidth LAN or WAN, or can also be connected to server 410 through network 440. The databases, including data store 422, can be split up so that they are located in multiple locales.

The client 430 can be any suitable computing device, such as computer, laptop, desktop, smartphone, mobile device, PDA, tablet, or other computing device. The client 430 can include a processor(s) 432 and a memory 434. The processor 432 can be any suitable processing device. The memory 434 can store computer-readable instructions that when executed by the processor 432 cause the processor(s) 432 to perform operations. The client 430 can include various input/output devices 436 for providing and receiving information from a player, such as a touch screen, touch pad, data entry keys, speakers, and/or a microphone suitable for voice recognition. For instance, the client 430 can include a display for presenting information to the user. The client 430 can further include a network interface 438 for providing communications over the network 440. The network interface can be any device/medium that allows the client to interface with the network 440.

Other systems can also be includes as part of the system. For instance, a client 430 can include a positioning system 442 used to determine the position of the client 430. The positioning system 442 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position. Positioning system 442 can collect position data that can be optionally shared with the server 410, for instance, to allow the group recommendation platform 110 to identify a plurality of candidate objects.

The client 430 can also include a proximity system 444 used to determine the proximity of the client 430 to other devices. The proximity system 444 can be, for instance, a Bluetooth system or other near field communication system. The proximity system 444 can be used, for instance, to join a group decision session by placing the client 430 in proximity with other devices.

The network 440 can be any type of communications network, such as a local area network (e.g. intranet), wide area network (e.g. Internet), or some combination thereof. The network 440 can also include a direct connection between a client 430 and the server 410. In general, communication between the server 410 and a client 430 can be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A computer-implemented method of providing a recommendation to a group of at least one object from a plurality of candidate objects, the method comprising:
identifying, by one or more computing devices, a plurality of keywords associated with the plurality of candidate objects from at least one data store storing information associated with the plurality of candidate objects;
generating, by the one or more computing devices, a plurality of selection queries, each selection query presenting two or more keywords, each keyword being identified for inclusion in the selection query based on a number of candidate objects associated with the keyword in the at least one data store;
providing, by the one or more computing devices, the plurality of selection queries to each of a plurality of users in the group, each of the plurality of selection queries requiring a user to select one or more of the plurality of keywords based on user preferences,
receiving, by the one or more computing devices, a response to each of to the plurality of selection queries from the plurality of users; and
generating, by the one or more computing devices, a recommendation for the plurality of candidate objects based on the responses to the plurality of selection queries.

2. The computer-implemented method of claim 1, wherein the method further comprises:
initiating, at the one or more computing devices, a group decision session; and
inviting, by the one or more computing devices, the plurality of users to participate in the group decision session.

3. The computer-implemented method of claim 1, wherein the recommendation is generated based on a ranking score generated for each of the plurality of candidate objects.

4. The computer-implemented method of claim 1, wherein each of the plurality of keywords is associated with a characteristic trait of at least one of the plurality of candidate objects.

5. The computer-implemented method of claim 1, wherein at least one of the plurality of selection queries requires the user to make a pairwise decision between two keywords.

6. The computer-implemented method of claim 1, wherein at least one of the plurality of selection queries requires the user to rank a plurality of keywords.

7. The computer-implemented method of claim 3, wherein generating a ranking score for each of the plurality of candidate objects based on the responses to the plurality of selection queries, comprises:
assigning by the one or more computing devices, a point value to a keyword based on the responses to the plurality of selection queries;
assigning, by the one or more computing devices, the point value to at least one candidate object associated with the keyword; and
summing, by the one or more computing devices, the point values assigned to each candidate object.

8. The computer-implemented method of claim 7, wherein the point value is assigned to the keyword based on a selection of the keyword in response to one of the plurality of selection queries.

9. The computer-implemented method of claim 7, wherein the point value is assigned to the keyword based on a ranking of the keyword provided in response to one of the plurality of selection queries.

10. The computer-implemented method of claim 1, wherein the method comprises:
assigning, by the one or more computing devices, a weighting value to one of the plurality of keywords based on the number of candidate objects associated with the keyword; and
selecting, by the one or more computing devices, the keyword for one of the plurality of selection queries based on the weighting value assigned to the keyword.

11. The computer-implemented method of claim 1, wherein the method comprises presenting a plurality of selection queries to the plurality of users until a condition is satisfied.

12. The computer-implemented method of claim 11, wherein the condition comprises the lapsing of a period of time or the receiving a predetermined number of responses.

13. The computer-implemented method of claim 1, wherein the method comprises:
receiving, by the one or more computing devices, a veto decision from one of the plurality of users; and
removing, by the one or more computing devices, a candidate object from the plurality of candidate objects based on the veto decision.

14. The computer-implemented method of claim 1, the plurality of candidate objects comprise a plurality of restaurants.

15. A computing system, comprising:
a display device;
a processor; and
a memory, the memory storing computer-readable instructions that when executed by the processor cause the processor to perform operations, the operations comprising:
receiving a plurality of selection queries via a network interface, each of the plurality of selection queries requiring a user to select one or more of a plurality of keywords based on user preferences, the plurality of keywords being associated with one or more objects in a plurality of candidate objects, at least one keyword of the plurality of keywords being selected for inclusion in the plurality of selection queries based at least in part on a number of candidate objects associated with the at least one keyword;
presenting each of the plurality of selection queries in a user interface presented on a display device;
receiving a response to each of the plurality of selection queries;
providing the responses to each of the plurality of selection queries to a remote device over a network interface; and
receiving at least one group recommendation of an object via the network interface, the at least one group recommendation being determined based on ranking scores generated for the plurality of candidate objects based on responses to each of the plurality of selection from a plurality of users; and
presenting the at least one group recommendation in the user interface.

16. The computing device of claim 15, wherein each of the plurality of keywords area associated with a characteristic trait of at least one of the plurality of candidate object

17. The computing device of claim 15, wherein at least one of the plurality of selection queries requires the user to make a pairwise decision between two keywords.

18. The computing device of claim 15, wherein at least one of the plurality of selection queries requires the user to rank a plurality of keywords.

19. A computer-implemented method of providing a recommendation of a restaurant to a group, the method comprising:
identifying, by one or more computing devices, a plurality of candidate restaurants;
identifying, by the one or more computing devices, a plurality of keywords associated with characteristic traits of the plurality of candidate restaurants from at least one data store storing information associated with the plurality of candidate objects;
generating, by the one or more computing devices, a plurality of selection queries, each selection query presenting two or more keywords, each keyword being identified for inclusion in the selection query based on a number of candidate objects associated with the keyword in the at least one data store;
providing, by the one or more computing devices
providing, by the one or more computing devices, a plurality of selection queries to a plurality of users in the group, each of the plurality of selection queries requiring a user to select one or more of the plurality of keywords based on user preferences;
receiving, by the one or more computing devices, a response to each of the plurality of selection queries from the plurality of users;
generating, by the one or more computing devices, a ranking score for each of the plurality of candidate restaurants based on the responses to the plurality of selection queries; and
providing, by the one or more computing devices, at least one group recommendation of a restaurant determined based on the ranking scores for the plurality of candidate restaurants.

20. The computer-implemented method of claim 19, wherein the plurality of candidate restaurants are identified based on position data associated with one or more of the plurality of users.
